(19) United States
(12) Patent Application Publication
(10) Pub. No.: US 2024/0322464 A1
(43) Pub. Date: Sep. 26, 2024

(54) ELECTRICAL CONNECTOR

(71) Applicant: J.S.T. Mfg. Co., Ltd., Tokyo (JP)

(72) Inventors: Masaki TSUJIMOTO, Yokohama-shi (JP); Hideya OKAZAKI, Yokohama-shi (JP)

(73) Assignee: J.S.T. Mfg. Co., Ltd., Tokyo (JP)

(21) Appl. No.: 18/611,375

(22) Filed: Mar. 20, 2024

(30) Foreign Application Priority Data
Mar. 22, 2023 (JP) 2023-044895

(51) Int. Cl. H01R 12/71; H01R 12/72; H01R 13/428; H01R 13/502

(52) U.S. Cl. CPC H01R 12/716; H01R 12/721; H01R 13/428; H01R 13/502

(57) ABSTRACT

An electrical connector includes a housing and a contact having a bellows contact structure. The contact has a substantially rectangular parallelepiped frame body including an upper-surface portion, a lower-surface portion, and a pair of side surface portions facing each other therebetween. At one end of the substantially rectangular parallelepiped frame body in a longitudinal direction, a contact-spring portion for contacting with a mating terminal is provided. At the other end of the substantially rectangular parallelepiped frame body in the longitudinal direction, a fixing portion that is fixed to the housing is provided. The contact has an elastic structure that is included in the substantially rectangular parallelepiped frame body interposed between the contact-spring portion and the fixing portion. The elastic structure of the contact is segmented into the upper-surface portion, the pair of side-surface portions, and the lower-surface portion of the substantially rectangular parallelepiped frame body.

This application is based on and claims the benefit of priority from Japanese Patent Application No. 2023-044895, filed on 22 Mar. 2023, the content of which is incorporated herein by reference.

### BACKGROUND OF THE INVENTION

### Field of the Invention

The present disclosure generally relates to an electrical connector. In particular, the present disclosure relates to a structure of an electrical connector electrically connectable to a battery (a rechargeable battery) incorporated in a portable electronic device such as a cellular phone.

### Related Art

An electrical connector for a battery is used to establish an electrical connection between the battery and an electronic device such as a cellular phone that operates using the battery as a power source.

In general, the electrical connector for the battery is configured as a small electrical connector (a connector on a printed circuit board) that can be mounted to a printed circuit board incorporated in an electronic device.

Such an electrical connector (hereinafter abbreviated to “connector”) for a battery is composed of an insulating housing and a plurality of contacts accommodated in the housing. Each contact includes a so-called snake spring that is formed by punching out a strip-shaped conductive metal plate into a meandering curve shape. A contact that has a snake spring is called a snake spring contact and is disclosed, for example, in Japanese Unexamined Patent Application, Publication No. 2010-118257.

The conventional snake spring contact disclosed in Japanese Unexamined Patent Application, Publication No. 2010-118257 includes a pair of spring portions (snake springs) extending parallel to each other in a meandering state from a pair of supporting metal plates with flat surfaces that face each other. The tips of the pair of spring portions are joined to each other to form a U-shaped bent portion, and the U-shaped bent portion serves as a contact portion for contacting with a mating terminal.

The pair of supporting metal plate portions is supported by an inner wall of the housing. The housing has an opening, and the contact portion for contacting with the mating terminal is configured to project outside from the opening of the housing. The pair of spring portions (snake springs) that extend in parallel to each other allows the contact portion for contacting with the mating terminal to have a higher contact pressure than one snake spring having the same spring length as the pair of spring portions.

However, the contact according to the conventional technology described above is disadvantageous in that the size of the contact is large both in the direction in which the mating terminal comes into contact (longitudinal direction) and in a width direction that is orthogonal to the longitudinal direction, which makes it difficult to reduce the size of the contact.

### SUMMARY OF THE INVENTION

The present disclosure has been achieved in consideration of such a problem, and an object of the present disclosure is to provide an electrical connector that is electrically connectable to a battery incorporated in a portable electronic device or the like, and that includes a contact configured to connect to a mating terminal, having a reduced size, and maintaining spring characteristics.

The inventors of the present invention consider that, by segmenting and arranging an elastic structure of a contact in the structure of a substantially rectangular parallelepiped frame body formed by bending a metal plate in three dimensions, it is possible to reduce the electrical connector in size, and thereby, the inventors arrived at inventing the following new electrical connector.

(1) A first aspect of the present disclosure relates to an electric connector including: one or more contacts having a bellows contact structure and being formed by bending a metal plate; and a housing having a substantially rectangular and parallelepiped shape and including the one or more contacts mounted therein. Each contact is configured to have a substantially rectangular parallelepiped frame body that includes an upper-surface portion, a lower-surface portion, and a pair of side-surface portions facing each other between the upper-surface portion and lower-surface portion. Each contact includes: a contact-spring portion having a contact point configured to contact with a mating terminal and formed at one end of the substantially rectangular parallelepiped frame body in a longitudinal direction; a fixing portion fixed to the housing and formed at another end of the substantially rectangular parallelepiped frame body in the longitudinal direction; and an elastic structure interposed between the contact-spring portion and the fixing portion. The housing has an accommodation chamber that accommodates at least the substantially rectangular parallelepiped frame body, and an opening that communicates with the accommodation chamber and allows the contact-spring portion to project outside. The elastic structure of each contact is segmented into the upper-surface portion, the pair of side-surface portions, and the lower-surface portion of the substantially rectangular parallelepiped frame body.

(2) According to a second aspect, in the electrical connector of the first aspect, the substantially rectangular parallelepiped frame body is configured such that the upper-surface portion has a band shape extending in the longitudinal direction and having a base end portion and a tip, the pair of side-surface portions have a pair of first meandering shapes each having a tip portion, the pair of first meandering shapes bending from both sides of the base end portion of the band shape so as to face each other and meandering parallel to each other toward the tip of the band shape, the lower-surface portion includes portions having a pair of second meandering shapes bending so as to approach each other from the tip portions of the first meandering shapes, respectively, the pair of second meandering shapes being formed in the longitudinal direction toward the base end portion of the band shape and meandering parallel to each other in a height direction between the lower-surface portion and the upper-surface portion via a space between the pair of side-surface portions, the contact-spring portion has a curved surface formed by the tip of the band shape projecting and extending toward the lower-surface portion while inclining in the longitudinal direction and curving back at its end, and the contact point includes the curved surface. The fixing portion is formed at each end of the pair of second meandering shapes.

(3) According to a third aspect of the present disclosure, in the electrical connector of the first aspect or the second aspect, the fixing portion includes a pair of press-fitting portions capable of press-fitting to the housing, and a pair of lead portion continuing from the press-fitting portions and capable of joining to one surface of a printed circuit board.

(4) According to a fourth aspect of the present disclosure, in the electrical connector of the second aspect or the third aspect, the pair of second meandering shapes are disposed so that surfaces in a thickness direction of the metal plate face each other with a predetermined interval therebetween.

### BRIEF DESCRIPTION OF THE DRAWINGS

FIG. 1 is a perspective view illustrating a configuration of an electrical connector according to an embodiment, in which the electrical connector is mounted on a printed circuit board;

FIG. 2 is a perspective exploded view illustrating the configuration of the electrical connector according to the embodiment;

FIG. 3 is a plan view illustrating the configuration of the electrical connector according to the embodiment;

FIG. 4 is a front view illustrating the configuration of the electrical connector according to the embodiment;

FIG. 5 is a rear view illustrating the configuration of the electrical connector according to the embodiment;

FIGS. 6A and 6B each illustrate the configuration of the electrical connector according to the embodiment, FIG. 6A is a front view illustrating a partial configuration of the electrical connector, and FIG. 6B is a cross-sectional view taken along a line indicated by arrows X, X in FIG. 6A;

FIGS. 7A to 7C each illustrate a configuration of a housing provided in the electrical connector according to the embodiment, FIG. 7A is a front view of the housing, FIG. 7B is a rear view of the housing, and FIG. 7C is a bottom view of the housing;

FIGS. 8A and 8B are each a perspective view illustrating a configuration of a contact provided in the electrical connector according to the embodiment, FIG. 8A illustrates a state of the contact as viewed from the front, and FIG. 8B illustrates a state of the contact as viewed from the rear;

FIGS. 9A and 9B are each a right-side view illustrating the configuration of the contact provided in the electrical connector according to the embodiment, FIG. 9A illustrates a state before the contact is elastically deformed, and FIG. 9B illustrates a state after the contact has been elastically deformed;

FIG. 10 is a bottom view illustrating the configuration of the contact provided in the electrical connector according to the embodiment; and

FIG. 11 is a developed view of a metal plate of the contact provided in the electrical connector according to the embodiment and illustrates a state before the contact is formed by bending.

### DETAILED DESCRIPTION OF THE INVENTION

The following describes embodiments of the present invention with reference to the accompanying drawings.

### Configuration of Electrical Connector

First, a configuration of an electrical connector according to an embodiment of the present disclosure will be described.

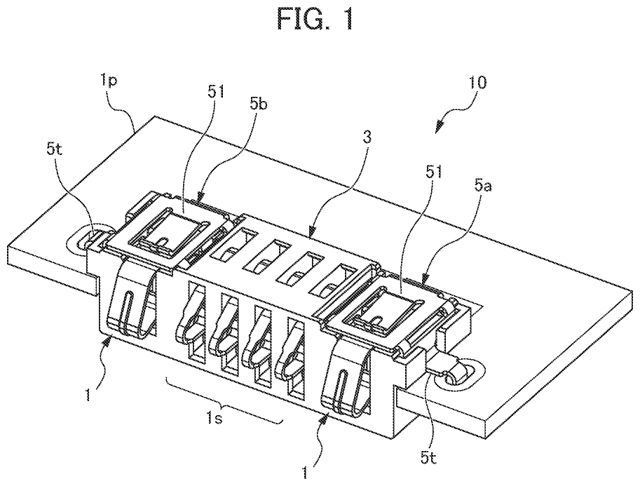

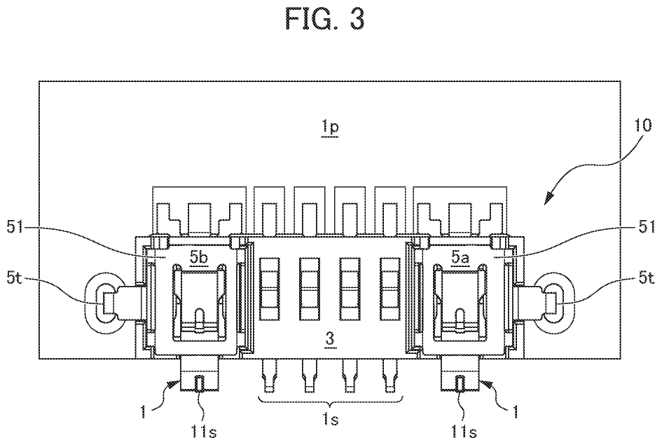

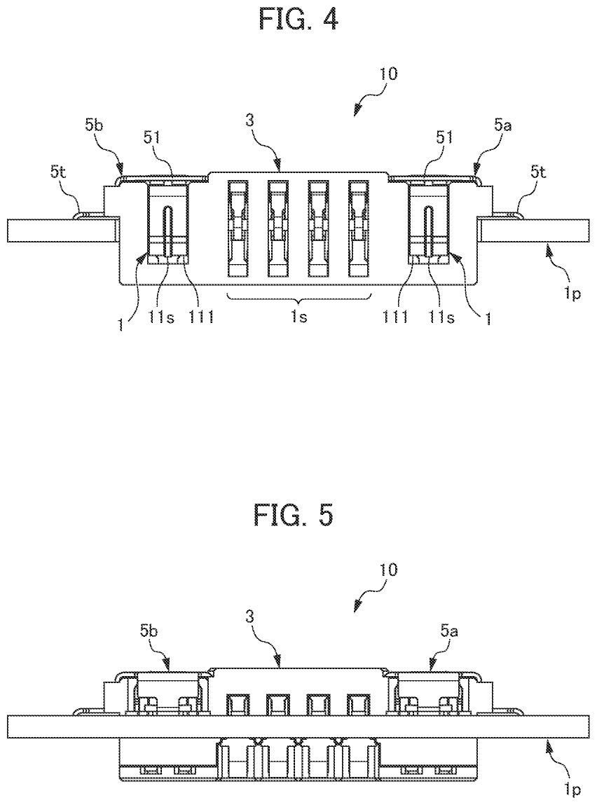

Referring to FIGS. 1 to 6A and 6B, the electrical connector (hereinafter abbreviated as a connector) 10 according to the embodiment of the present disclosure can be electrically connected to a battery (not shown) built into a cellular phone or the like. The connector 10 includes a pair of contacts 1, 1 and a housing 3, each contact 1 of the pair of contacts 1, 1 having a bellows contact structure, the housing 3 having a substantially rectangular parallelepiped shape.

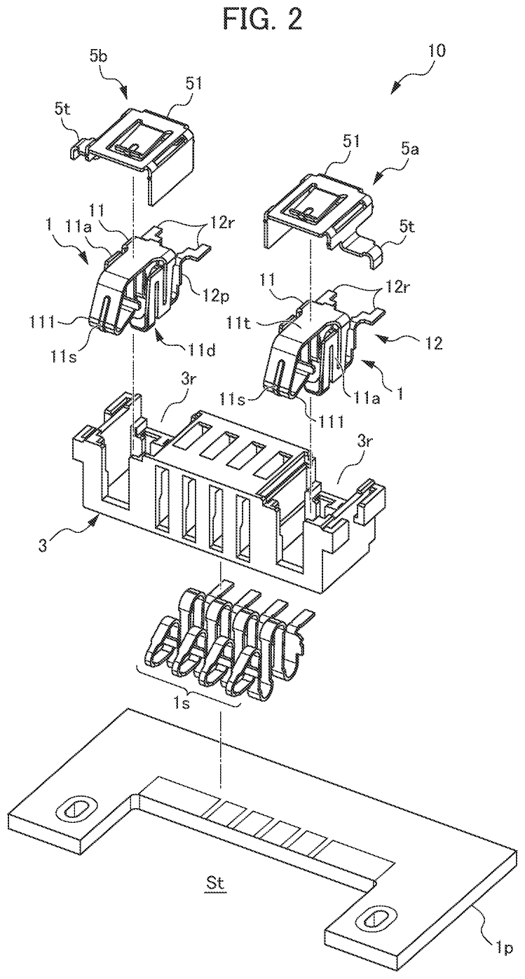

Referring to FIG. 2 or FIG. 6B and FIGS. 8A and 8B, each contact 1 of the pair of contacts 1, 1 is formed by punching and bending a strip-shaped metal plate into a predetermined shape. Each contact 1 is mounted inside the housing 3. More specifically, each contact 1 has a substantially rectangular parallelepiped frame body 11 that is configured to be accommodated in an accommodation chamber 3r provided in the housing 3. In addition, the housing 3 has a pair of openings 3w that communicate with the accommodation chamber 3r. The contact 1 has a contact-spring portion 111 that is configured to project outside from an opening 3w of the pair of openings 3w.

Referring to FIG. 1 or FIG. 2, the contacts 1 are each a power supply contact configured to connect to a power supply terminal of a mating terminal and are disposed at both end portions of the housing 3. The connector 10 includes a plurality of signal contacts 1s. The plurality of signal contacts 1s is connected to a signal terminal of the mating terminal and is arranged in parallel between the pair of contacts 1, 1. Referring to FIG. 2, each signal contact 1s is composed of a snake spring having a header that has a bellows contact structure.

Referring to FIG. 1 or FIG. 2, the connector 10 is mounted on a printed circuit board 1p. The printed circuit board 1p has a rectangular slot St cut out at the edge thereof. The connector 10 is introduced into the rectangular slot St, bottom side of the housing 3 first. Each contact 1 includes lead portions 12r, and each signal contact 1s includes a lead portion. The lead portions 12r and the lead portion of each signal contact 1s are bonded to a pad provided on the printed circuit board 1p by, for example, solder. With this configuration, it is possible to mount the connector 10 on the printed circuit board 1p at a lower height.

Referring to FIGS. 1 to 5, the connector 10 further includes a pair of heat radiation terminals 5a and 5b. Each of the heat radiation terminals 5a and 5b has a rectangular radiation plate 51 and a reinforcing tab 5t. The contact 1 has an upper-surface portion 11t, and the heat radiation plate 51 has a center portion that contacts the upper-surface portion 11t. With this configuration, it is possible for the heat radiation plate 51 to act on the thermal conduction of the contact 1. In addition, the reinforcing tab 5t has an end portion that is solder-bonded to a through hole provided in the printed circuit board 1p. The reinforcing tab 5t further improves the bonding strength of the connector 10 to the printed circuit board 1p.

### Configuration of Contact

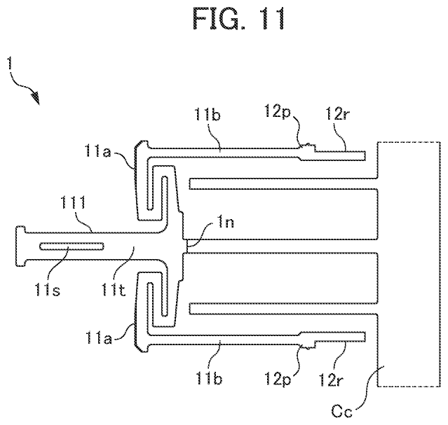

The following describes a configuration of the contact 1. The contact 1 is made of a conductive metal plate, and it is possible to provide the contact 1 with a desired shape by bending the metal plate punched into the shape shown in FIG. 11. The metal plate constituting the contact 1 is preferably a metal plate that is conductive such as a copper alloy plate, but is not limited to such a copper alloy plate.

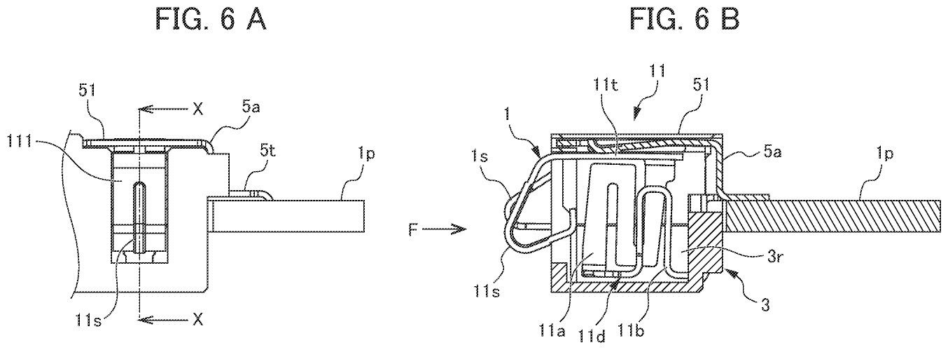

Referring to FIG. 6B or FIGS. 8A and 8B and FIGS. 9A and 9B, the contact 1 has the substantially rectangular parallelepiped frame body 11 that includes the upper-surface portion 11t, a lower-surface portion 11d, and a pair of side-surface portions 11a, 11a facing each other between the upper-surface portion 11t and the lower-surface portion 11d. At one end of the substantially rectangular parallelepiped frame body 11 in a longitudinal direction, a contact-spring portion 111 is provided which has thereon a contact point 11s for contacting with a mating terminal. At the other end of the substantially rectangular parallelepiped frame body 11 in the longitudinal direction, a fixing portion 12 that is fixed to the housing 3 is provided. The contact 1 has an elastic structure that is included in the substantially rectangular parallelepiped frame body 11, which connects the contact-spring portion 111 to the fixing portion 12. That is, the elastic structure of the contact 1 is segmented into the upper-surface portion 11t, the pair of side-surface portions 11a, 11a, and the lower-surface portion 11d of the substantially rectangular parallelepiped frame body 11.

More specifically, the substantially rectangular parallelepiped frame body 11 has the following configuration. The upper-surface portion 11t has a band shape extending in the longitudinal direction and having a base end portion and a tip. The pair of side-surface portions 11a, 11a have a pair of first meandering shapes each having a tip portion, the pair of first meandering shapes bending from both sides of the base end portion of the band shape so as to face each other and meandering parallel to each other toward the tip of the band shape. The lower-surface portion 11d includes portions having a pair of second meandering shapes bending so as to approach each other from the tip portions of the first meandering shapes, respectively. The pair of second meandering shapes are formed in the longitudinal direction toward the base end portion of the band shape, and meander parallel to each other in a height direction between the lower-surface portion 11d and the upper-surface portion 11t via a space between the pair of side-surface portions 11a, 11a. The pair of second meandering shapes is composed of a pair of bottom-plate portions 11b, 11b arranged such that the surfaces in the thickness direction of the metal plate face each other with a predetermined interval therebetween.

The contact-spring portion 111 has a curved surface formed by the tip of the band shape of the upper-surface portion 11t projecting and extending toward the lower-surface portion 11d while inclining in the longitudinal direction and curving back at its end. The contact point 11s includes this curved surface. The contact point 11s has a convex portion formed by processing the metal plate that includes this curved surface.

The fixing portion 12 is formed at each end of the pair of second meandering shapes, that is, at each end of the pair of bottom-plate portions 11b, 11b. The fixing portion 12 has a structure that can be fixed to the housing 3 from the upper surface of the housing 3. The fixing portion 12 includes, at the end portions of the pair of bottom plate portions 11b, 11b, a pair of press-fitting portions 12p, 12p and a pair of lead portions 12r, 12r. The pair of press-fitting portions 12p, 12p capable of press-fitting to an inner wall of the accommodation chamber 3r of the housing 3. The pair of lead portions 12r, 12r continue from the press-fitting portions and are capable of joining to one surface of the printed circuit board 1p (see FIG. 2).

The contact 1 can be obtained by bending a metal plate as shown in FIG. 11. The contact 1 after bending is connected to a strip-shaped contact carrier Cc. A plurality of the contacts 1 may be provided consecutively in a direction in which the contact carrier Cc extends. By cutting a notch 1n, each contact 1 (see FIG. 2) can be obtained separate from the contact carrier Cc.

### Configuration of Housing

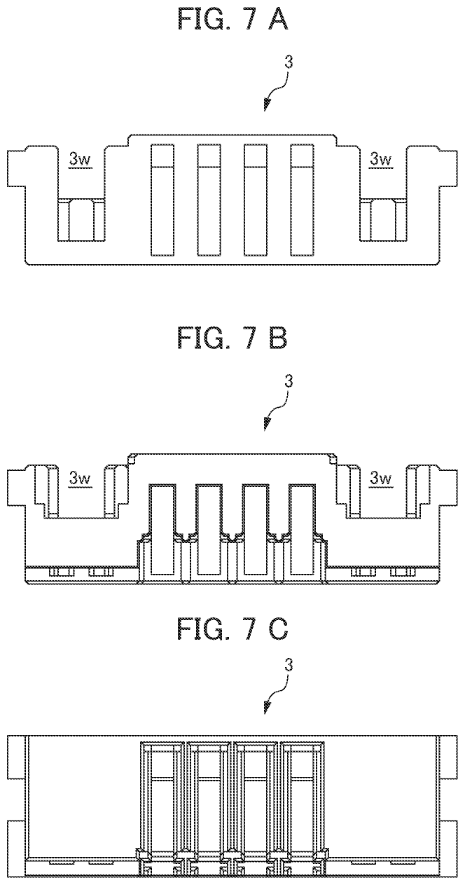

Referring to FIG. 2 or 6B and 7A to 7C, the housing 3 is formed in a rectangular parallelepiped shape, and has, at both ends in the longitudinal direction, a pair of accommodation chambers 3r, 3r and a pair of openings 3w, 3w. At least the substantially rectangular parallelepiped frame body 11 of the contact 1 can be accommodated in the accommodation chamber 3r. Each pair of opening 3w communicates with one of the accommodation chambers 3r. The opening 3w of the pair of openings 3w allows the contact-spring portion 111 of the contact 1 to project outside. The signal contacts 1s can be mounted in the housing 3 from underneath the housing 3.

### Operation of Electrical Connector

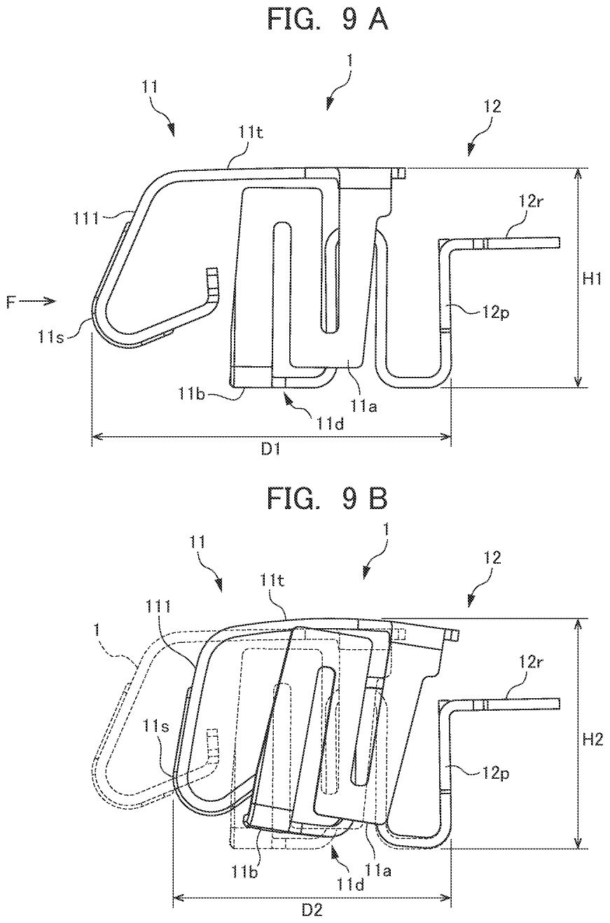

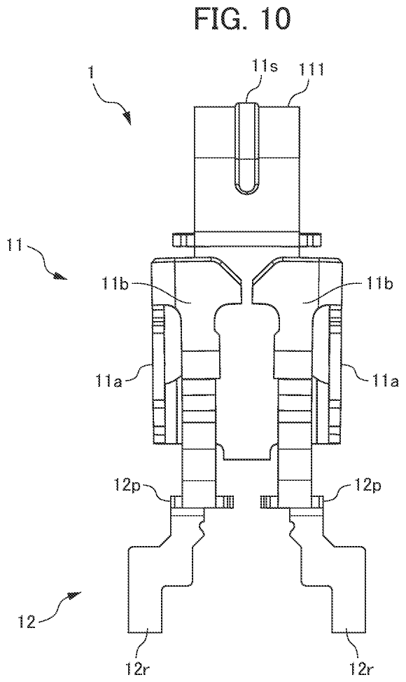

The following describes the operation and effect of the connector 10 while explaining the deformation operation of the contact 1. Referring to FIG. 6B, in a case in which a battery (not shown) moves toward the contact point 11s (in the direction of arrow F) with an electrode terminal facing the contact point 11s, the contact 1 elastically deforms from the state illustrated in FIG. 9A to the state illustrated in FIG. 9B in response to a force indicated by arrow F illustrated in FIG. 9A. The contact point 11s retracts toward the pair of press-fitting portions 12p, 12p.

In a process of elastically deforming the substantially rectangular parallelepiped frame body 11 from the state shown in FIG. 9A to the state illustrated in FIG. 9B, the substantially rectangular parallelepiped frame body 11 is not easily elastically deformed, and as illustrated in FIG. 9B, the contact-spring portion 111, the upper-surface portion 11t (band shape), the pair of side-surface portions 11a, 11a (first meandering shapes), and the pair of bottom-plate portions 11b, 11b (second meandering shapes) are elastically deformed in response to the force indicated by the arrow F.

Referring to FIGS. 9A and 9B, the contact 1 according to the embodiment is displaced from D1 to D2 in a depth direction (longitudinal direction) and from H1 to H2 in the height direction in response to the force indicated by the arrow F. A displacement amount in the height direction is clearly smaller compared to a displacement amount in the depth direction (longitudinal direction). On the other hand, the contact-spring portion 111 and the upper-surface portion 11t (band shape) are susceptible to bending in the height direction, and a wiping effect in which the contact point 11s slides with the electrode terminal can be sufficiently obtained. That is, the contact 1 according to the embodiment can ensure a sufficient wiping amount while being a small contact.

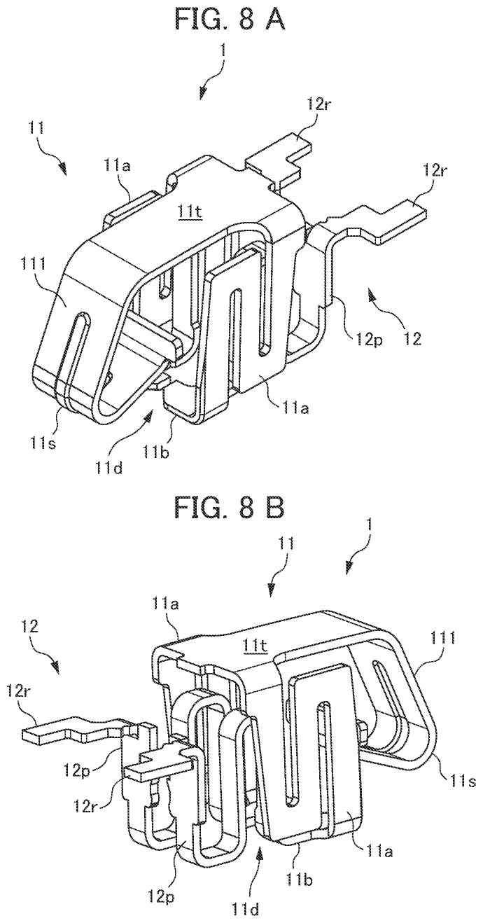

In the connector 10 according to the embodiment, the metal plate of the contact 1 is bent in three dimensions to form a rectangular prism frame (the substantially rectangular parallelepiped frame body 11), and each of the surfaces of the substantially rectangular parallelepiped frame body 11 function as a spring portion. That is, referring to FIGS. 8A and 8B or FIGS. 9A and 9B, the upper-surface portion 11t functions as a first spring portion. The pair of side-surface portions 11a, 11a (first meandering shapes) functions as a second spring portion. The pair of bottom-plate portions 11b, 11b (second meandering shapes) functions as a third spring portion. In this way, each surface of the substantially rectangular parallelepiped frame body 11 can be ensured to have a spring performance, and the connector 10 can be made compact in the width direction and in the depth direction. That is, the size of the connector 10 can be reduced.

Referring to FIGS. 8A and 8B or FIGS. 9A and 9B, by adjusting the balance of the first to third spring portions in the substantially rectangular parallelepiped frame body 11 of the contact 1, it is possible to make the height H1 of the contact 1 as small as possible while ensuring an appropriate contact pressure, and reduce the height of the connector 10.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. An electric connector comprising:
one or more contacts having a bellows contact structure and being formed by bending a metal plate; and
a housing having a substantially rectangular and parallelepiped shape and including the one or more contacts mounted therein,
wherein each contact is configured to have a substantially rectangular parallelepiped frame body that includes an upper-surface portion, a lower-surface portion, and a pair of side-surface portions facing each other between the upper-surface portion and lower-surface portion, each contact includes:
a contact-spring portion having a contact point configured to contact with a mating terminal and formed at one end of the substantially rectangular parallelepiped frame body in a longitudinal direction;
a fixing portion fixed to the housing and formed at another end of the substantially rectangular parallelepiped frame body in the longitudinal direction; and
an elastic structure interposed between the contact-spring portion and the fixing portion,
wherein the housing has an accommodation chamber that accommodates at least the substantially rectangular parallelepiped frame body, and an opening that communicates with the accommodation chamber and allows the contact-spring portion to project outside, and
the elastic structure of each contact is segmented into the upper-surface portion, the pair of side-surface portions, and the lower-surface portion of the substantially rectangular parallelepiped frame body.

2. The electrical connector according to claim 1, wherein
the substantially rectangular parallelepiped frame body is configured such that the upper-surface portion has a band shape extending in the longitudinal direction and having a base end portion and a tip,
the pair of side-surface portions have a pair of first meandering shapes each having a tip portion, the pair of first meandering shapes bending from both sides of the base end portion of the band shape so as to face each other and meandering parallel to each other toward the tip of the band shape,
the lower-surface portion includes portions having a pair of second meandering shapes bending so as to approach each other from the tip portions of the first meandering shapes, respectively, the pair of second meandering shapes being formed in the longitudinal direction toward the base end portion of the band shape and meandering parallel to each other in a height direction between the lower-surface portion and the upper-surface portion via a space between the pair of side-surface portions,
the contact-spring portion has a curved surface formed by the tip of the band shape projecting and extending toward the lower-surface portion while inclining in the longitudinal direction and curving back at its end, the contact point includes the curved surface, and
the fixing portion is formed at each end of the pair of second meandering shapes.

3. The electrical connector according to claim 1, wherein the fixing portion includes
a pair of press-fitting portions capable of press-fitting to the housing, and
a pair of lead portion continuing from the press-fitting portion and capable of joining to one surface of a printed circuit board.

4. The electrical connector according to claim 2, wherein the pair of second meandering shapes are disposed so that surfaces in a thickness direction of the metal plate face each other with a predetermined interval therebetween.

5. The electrical connector according to claim 2, wherein the fixing portion includes
a pair of press-fitting portions capable of press-fitting to the housing, and
a pair of lead portion continuing from the press-fitting portion and capable of joining to one surface of a printed circuit board.

6. The electrical connector according to claim 3, wherein the pair of second meandering shapes are disposed so that surfaces in a thickness direction of the metal plate face each other with a predetermined interval therebetween.
